(19) United States
(12) Patent Application Publication
(10) Pub. No.: US 2025/0216609 A1
(43) Pub. Date: Jul. 3, 2025

(54) QUANTUM LIGHT SOURCE DEVICE AND OPTICAL SYSTEM INCLUDING THE SAME

(71) Applicants: Electronics and Telecommunications Research Institute, Daejeon (KR); Korea Advanced Institute of Science and Technology, Daejeon (KR)

(72) Inventors: Kiwon MOON, Daejeon (KR); Hyeon HWANG, Daejeon (KR); Min-Kyo SEO, Daejeon (KR); Hansuek LEE, Daejeon (KR); Jung Jin JU, Daejeon (KR); Min-su KIM, Daejeon (KR); Hong-Seok KIM, Daejeon (KR); Jaegyu PARK, Daejeon (KR); Tetiana Slusar, Daejeon (KR); Jinwoo KIM, Daejeon (KR); Jin Tae KIM, Daejeon (KR); Jiho PARK, Daejeon (KR)

(73) Assignees: Electronics and Telecommunications Research Institute, Daejeon (KR); Korea Advanced Institute of Science and Technology, Daejeon (KR)

(21) Appl. No.: 18/975,769

(22) Filed: Dec. 10, 2024

(30) Foreign Application Priority Data
Dec. 27, 2023 (KR) 10-2023-0192702
Aug. 2, 2024 (KR) 10-2024-0103375

(51) Int. Cl. G02B 6/126; G02B 6/12

(52) U.S. Cl. CPC G02B 6/126; G02B 2006/1204; G02B 2006/12061; G02B 2006/12121; G02B 2006/12138

(57) ABSTRACT

Disclosed are a quantum light source device and an optical system including the same. The quantum light source device includes a substrate, a buffer layer provided on the substrate, and an optical waveguide layer provided on the buffer layer and including a signal waveguide and a resonant waveguide adjacent to one side of the signal waveguide. The resonant waveguide includes a periodic polarization inversion structure having a plurality of polarizations periodically inverted.

### CROSS-REFERENCE TO RELATED APPLICATIONS

This U.S. non-provisional patent application claims priority under 35 U.S.C. § 119 of Korean Patent Application No. 10-2023-0192702, filed on Dec. 27, 2023, and No. 10-2024-0103375, field on Aug. 2, 2024, the entire contents of which are hereby incorporated by reference.

### BACKGROUND

The present disclosure herein relates to an optical system, and more particularly, to a quantum light source device for generating a pair of entangled photons and an optical system including the same.

Quantum information communication indicates the whole technology area for generating, controlling, measuring, and analyzing quantum states in order to apply the quantum mechanical characteristics to information communication technology. Key areas of the quantum information communication are classified as quantum communication, quantum computing, quantum sensing, and measurement, and a quantum information state in most of quantum information communication technology area is represented by quantum bits (qubits) that are an extended concept of bits that are basic units of information used in classical information communication technology. Unlike the bits, the qubits may be subject to the superposition principle, namely, have information states corresponding to quantum states |0> and |1> at the same time.

Therefore, the qubits enable a whole new technology and system configuration beyond the technical limit of the classical information communication technology to attract great attention as future information communication technology, and some of them are already applied to systems and services.

### SUMMARY

The present disclosure provides a quantum light source device capable of increasing or maximizing spontaneous parametric down-conversion efficiency and an optical system including the same.

An embodiment of the inventive concept provides a quantum light source device including: a substrate; a buffer layer provided on the substrate; and an optical waveguide layer provided on the buffer layer and including a signal waveguide and a resonant waveguide adjacent to one side of the signal waveguide. Here, the resonant waveguide may include a periodic polarization inversion structure having a plurality of polarizations periodically inverted.

In an embodiment, the optical waveguide layer may include lithium niobate.

In an embodiment, the resonant waveguide may include: a main resonant waveguide adjacent to the signal waveguide; and an auxiliary resonant waveguide spaced apart from the signal waveguide and disposed adjacent to the main resonant waveguide.

In an embodiment, the quantum light source device may further include: a first outer resonant electrode provided out of the main resonant waveguide; and a first inner resonant electrode provided in the main resonant waveguide adjacent to the first outer resonant electrode

In an embodiment, the quantum light source device may further include: a second outer resonant electrode provided out of the auxiliary resonant waveguide; and a second inner resonant electrode provided in the auxiliary resonant waveguide adjacent to the second outer resonant electrode.

In an embodiment, the first and second outer resonant electrodes may include heater electrodes.

In an embodiment, the main resonant waveguide may include: a first main resonant waveguide; and a second main resonant waveguide provided in the first main resonant waveguide.

In an embodiment, the auxiliary resonant waveguide may include: a first auxiliary resonant waveguide; and a second auxiliary resonant waveguide provided in the first auxiliary resonant waveguide.

In an embodiment, the quantum light source device may further include: a third outer resonant electrode provided out of the resonant waveguide and in one side of the periodic polarization inversion structure; and a third inner resonant electrode provided in the resonant waveguide and in another side of the periodic polarization inversion structure.

In an embodiment, each of the signal waveguide and the resonant waveguide may include a ridge waveguide.

In an embodiment of the inventive concept, an optical system includes: a light source configured to generate pump light; a quantum light source device configured to use the pump light to generate a photon pair; and a light detector configured to detect the photon pair. The quantum light source device may include: a substrate; a buffer layer provided on the substrate; and an optical waveguide layer provided on the buffer layer and including a signal waveguide and a resonant waveguide adjacent to one side of the signal waveguide. The resonant waveguide may include a periodic polarization inversion structure having a plurality of polarizations periodically inverted.

In an embodiment, each of the signal waveguide and the resonant waveguide may include a ridge waveguide.

In an embodiment, the optical waveguide layer may include lithium niobate.

In an embodiment of the inventive concept, a quantum light source device includes: a signal waveguide; a resonant waveguide provided at one side of the signal waveguide; and a periodic polarization inversion structure provided on the resonant waveguide and having polarizations periodically inverted.

In an embodiment, the resonant waveguide may include: a main resonant waveguide adjacent to the signal waveguide; and an auxiliary resonant waveguide spaced apart from the signal waveguide and disposed adjacent to the main resonant waveguide.

In an embodiment, the quantum light source device may further include: a first outer resonant electrode provided out of the main resonant waveguide; and a first inner resonant electrode provided in the main resonant waveguide adjacent to the first outer resonant electrode; a second outer resonant electrode provided out of the auxiliary resonant waveguide; and a second inner resonant electrode provided in the auxiliary resonant waveguide adjacent to the second outer resonant electrode.

In an embodiment, the main resonant waveguide may include: a first main resonant waveguide; and a second main resonant waveguide provided in the first main resonant waveguide.

In an embodiment, the auxiliary resonant waveguide may include: a first auxiliary resonant waveguide; and a second auxiliary resonant waveguide provided in the first auxiliary resonant waveguide.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view showing an example optical system according to the present inventive concept;

FIG. 2 is a cross-sectional view showing an example quantum light source of FIG. 1;

FIG. 3 is a flowchart showing a manufacturing method of the quantum light source 30 of FIG. 1;

FIGS. 4 to 6 are process cross-sectional views of the quantum light source of FIG. 1;

FIG. 7 is a flowchart showing a manufacturing method of a periodic polarization inversion structure of FIG. 1;

FIGS. 8 to 10 are process plan views of the periodic polarization inversion structure of FIG. 1;

FIG. 11 is a plan view showing an example optical system according to the present inventive concept;

FIG. 12 is an example optical system according to the present inventive concept;

FIG. 13 is a plan view showing an example optical system according to the present inventive concept;

FIG. 14 is an example optical system according to the present inventive concept; and

FIG. 15 is an example optical system according to the present inventive concept.

### DETAILED DESCRIPTION

Hereinafter, exemplary embodiments of the present disclosure will be described in conjunction with the accompanying drawings. The above and other aspects, features, and advantages of the present disclosure will become apparent from the detailed description of the following embodiments in conjunction with the accompanying drawings. However, it should be understood that the present invention is not limited to the following embodiments and may be embodied in different ways. Rather, the embodiments are provided so that so that this disclosure will be thorough and complete and will fully convey the concept of the invention to those skilled in the art, and the present disclosure will only be defined by the appended claims. Throughout this specification, like numerals refer to like elements.

The terminology used herein is for the purpose of describing particular embodiments only and is not intended to limit the scope of the present disclosure. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Also, as just exemplary embodiments, reference numerals shown according to an order of description are not limited to the order.

Moreover, exemplary embodiments will be described herein with reference to cross-sectional views and/or plane views that are idealized exemplary illustrations. In the drawings, the thickness of layers and regions are exaggerated for effective description of the technical details. Accordingly, variations from the shapes of the illustrations as a result, for example, of manufacturing techniques and/or tolerances, are to be expected. Thus, exemplary embodiments should not be construed as limited to specific shapes illustrated herein but are to include deviations in shapes that result from manufacturing.

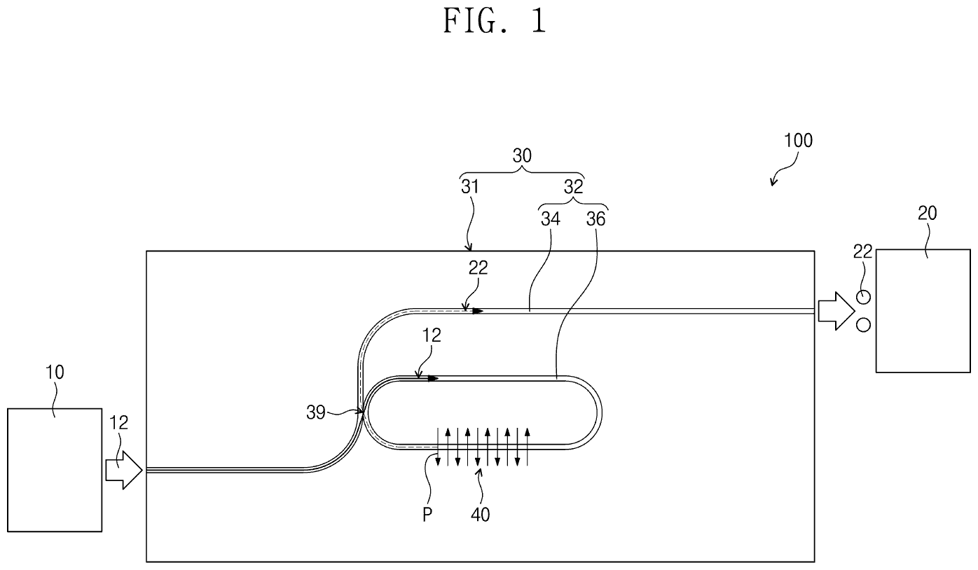

FIG. 1 shows an example optical system 100 according to the present inventive concept.

Referring to FIG. 1, the optical system 100 may include an optical quantum information communication system. According to an example, the optical system 100 may include a pump light source 10, a light detector 20, and a quantum light source device 30.

The pump light source 10 may generate pump light 12. The pump light 12 may include laser light. For example, the pump light source 10 may include an optical fiber laser device. The pump light source 10 may include a solid state laser device, but is not limited thereto.

The light detector 20 may receive a pair of photons 22 or an optical signal. The light detector 20 may include a photodiode, but is not limited thereto. Although not shown, the light detector 20 may be connected to a control unit.

The quantum light source device 30 may be provided between the pump light source 10 and the light detector 20. The quantum light source device 30 may use the pump light 12 to generate the photon pair 22. The photon pair 22 may include an entangled photon pair.

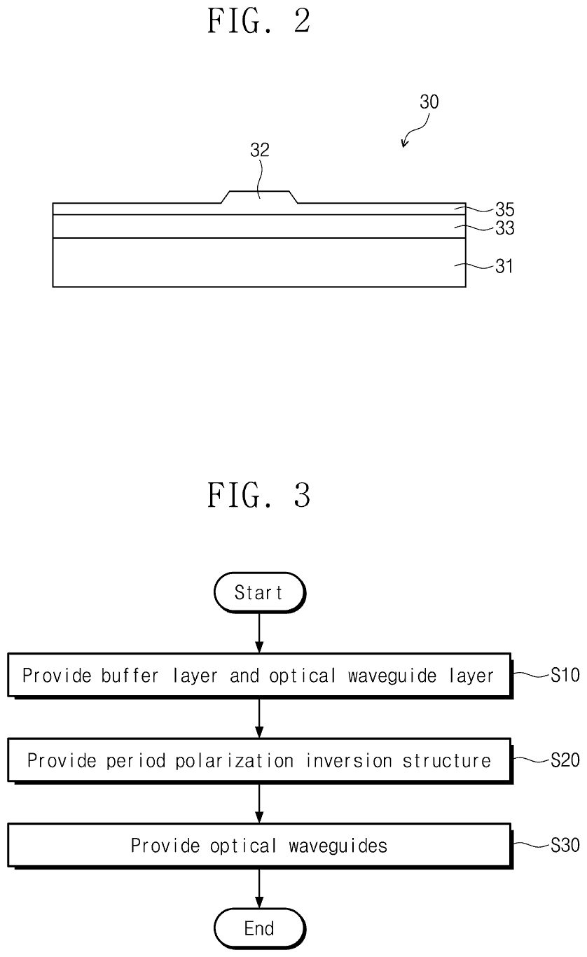

FIG. 2 shows an example of the quantum light source device 30 of FIG. 1.

Referring to FIGS. 1 and 2, the quantum light source device 30 may include a substrate 31, a buffer layer 33, an optical waveguide layer 35, and an optical waveguide 32.

The substrate 31 may include a silicon substrate.

The buffer layer 33 may be provided on the substrate 31. The buffer layer 33 may include a silicon oxide.

The optical waveguide layer 35 may be provided on the buffer layer 33. The optical waveguide layer 35 may include a lithium niobate oxide (LiNbO₃). For example, the optical waveguide layer 35 may have the optical waveguide 32. The optical waveguide 32 may include a ridge waveguide.

According to an example, the optical waveguide 32 may include a signal waveguide 34 and a resonant waveguide 36.

The signal waveguide 34 may extend from one side to the other side of the substrate 31. Namely, the signal waveguide 34 may extend from the pump light source 10 to the light detector 20. The signal waveguide 34 may provide the pump light 12 of the pump light source 10 to the resonant waveguide 36. The signal waveguide 34 may transfer the photon pair 22 generated in the resonant waveguide 36 to the light detector 20. The signal waveguide 34 may be rounded. For example, the signal waveguide 34 may have an S shape when viewed from a plan view. As an alternative, the signal waveguide 34 may extend in one direction, but is not limited thereto.

The resonant waveguide 36 may be provided in one side of the signal waveguide 34. The resonant waveguide 36 may have an elliptical or circular shape when viewed from a plan view. The resonant waveguide 36 may have a coupling unit 39 with a certain spacing from the signal waveguide 34. The resonant waveguide 36 may receive the pump light 12 from the signal waveguide 34 via the coupling unit 39 to generate the photon pair 22. According to an example, the resonant waveguide 36 may have a periodic polarization inversion structure 40. The periodic polarization inversion structure 40 may be provided on the resonant waveguide 36.

The periodic polarization inversion structure 40 may include polarizations P periodically inverted along the resonant waveguide 36. The periodic polarization inversion structure 40 may use the pump light 12 to generate the photon pair 22. For example, the periodic polarization inversion structure 40 may generate an entangled photon pair through a spontaneous parametric down-conversion (SPDC) process. The photon pair 22 may be resonated in the resonant waveguide 36. The photon pair 22 may be transferred to the signal waveguide 34 via the coupling unit 39 of the resonant waveguide 36 and the signal waveguide 34.

Accordingly, the quantum light source device 30 of the inventive concept may use the periodic polarization inversion structure 40 on the resonant waveguide 36 to increase or maximize spontaneous parametric down-conversion efficiency.

A manufacturing method of the quantum light source device 30 configured in this way is as follows.

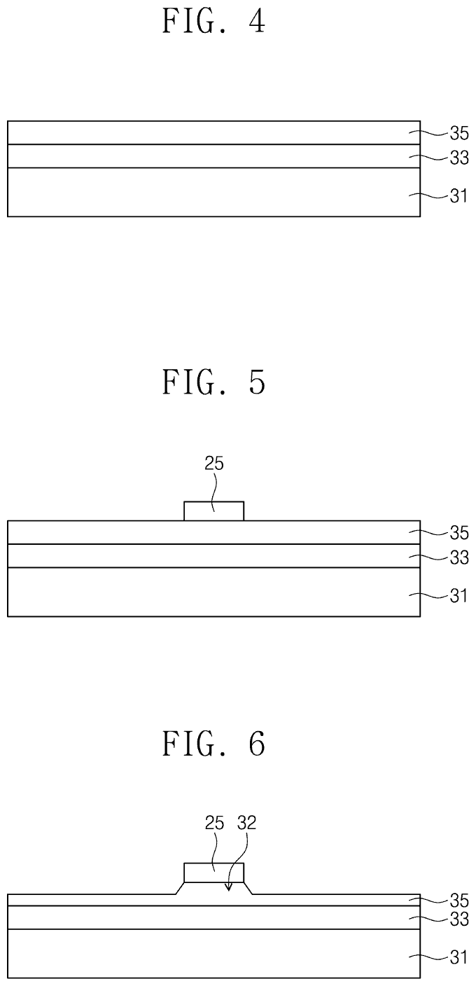

FIG. 3 is a flowchart showing the manufacturing method of the quantum light source 30 of FIG. 1. FIGS. 4 to 6 are process cross-sectional views of the quantum light source 30 of FIG. 1.

Referring to FIGS. 3 and 4, the buffer layer 33 and the optical waveguide layer 35 are provided on the substrate 31 (step S10). The buffer layer 33 may be provided by physical vapor deposition or chemical vapor deposition of the silicon oxide. The optical waveguide layer 35 may be provided by wafer bonding of the lithium niobate oxide (LiNbO₃).

Referring to FIG. 3, the periodic polarization inversion structure 40 is provided in the optical waveguide layer 35 (step S20).

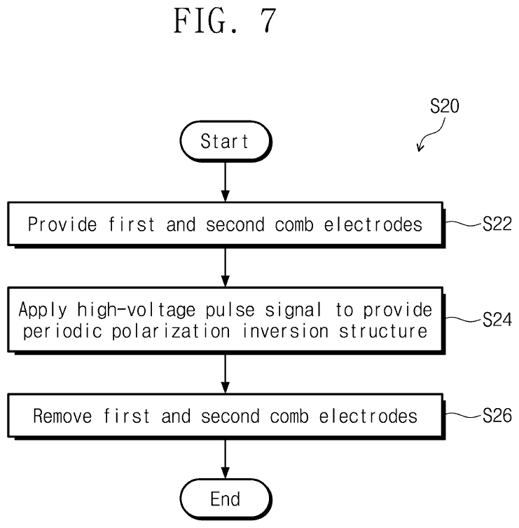

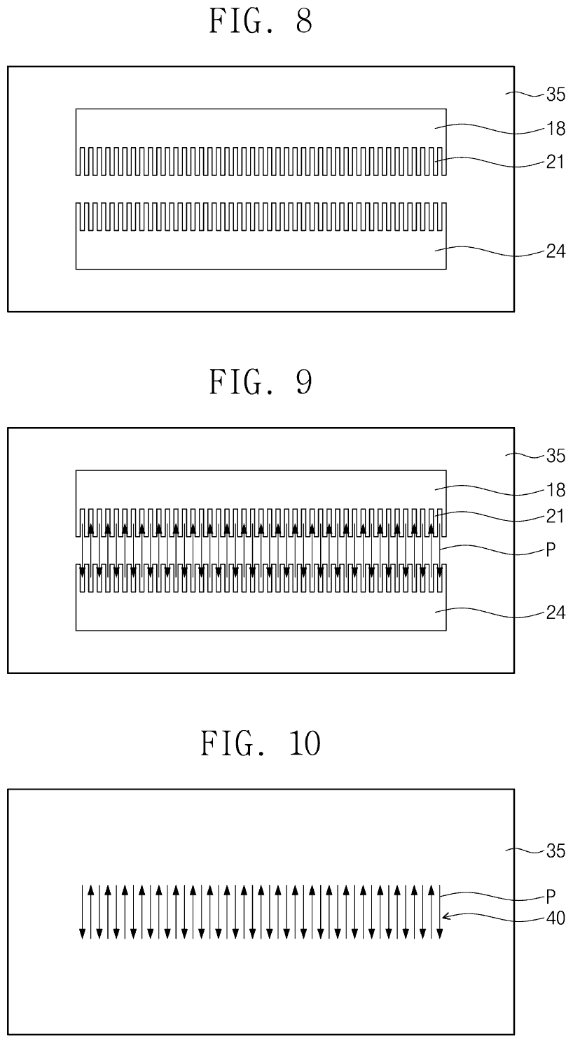

FIG. 7 is a flowchart showing the manufacturing method of the periodic polarization inversion structure 40 of FIG. 1. FIGS. 8 to 10 are process plan views of the periodic polarization inversion structure 40 of FIG. 1.

Referring to FIGS. 7 and 8, a first comb electrode 18 and a second comb electrode 24 are provided on the optical waveguide layer 50 (step S22). The first comb electrode 18 and the second comb electrode 24 may be provided through metal deposition processes, lithography processes, and etching processes. The first comb electrode 18 and the second comb electrode 24 may be provided adjacent to each other. Combs 21 of the first comb electrode 18 and the second comb electrode 24 may be provided opposite to each other.

Referring to FIGS. 7 and 9, the periodic polarization inversion structure 40 may be provided in the optical waveguide layer 35 by applying a high-voltage pulse signal to the first comb electrode 18 and the second comb electrode 24 (step S24). The periodic polarization inversion structure 40 may be provided under the combs 21 of the first comb electrode 18 and the second comb electrode 24.

Referring to FIGS. 7 and 10, the first comb electrode 18 and the second comb electrode 24 are removed (step S26). The first comb electrode 18 and the second comb electrode 24 may be removed through wet etching processes or wet cleaning processes.

Referring to FIGS. 2, 3, 5, and 6, the optical waveguides 32 are provided (step S30). The optical waveguides 32 may be provided through lithography processes and etching processes.

Referring to FIG. 5, a mask pattern 25 is provided on the optical waveguide layer 35. The mask pattern 25 may be provided on the optical waveguide layer 35 through a lithography process. The mask pattern 25 may include a photoresist.

Referring to FIG. 6, a portion of the optical waveguide layer 35 is etched using the mask pattern 25 as an etching mask, thereby providing the optical waveguides 32. The optical waveguide layer 35 may be etched by wet etching or dry etching.

Referring to FIG. 2, the mask pattern 25 may be etched or cleaned. The top of the optical waveguides 32 may be exposed. The optical waveguides 32 may protrude from the optical waveguide layer 35.

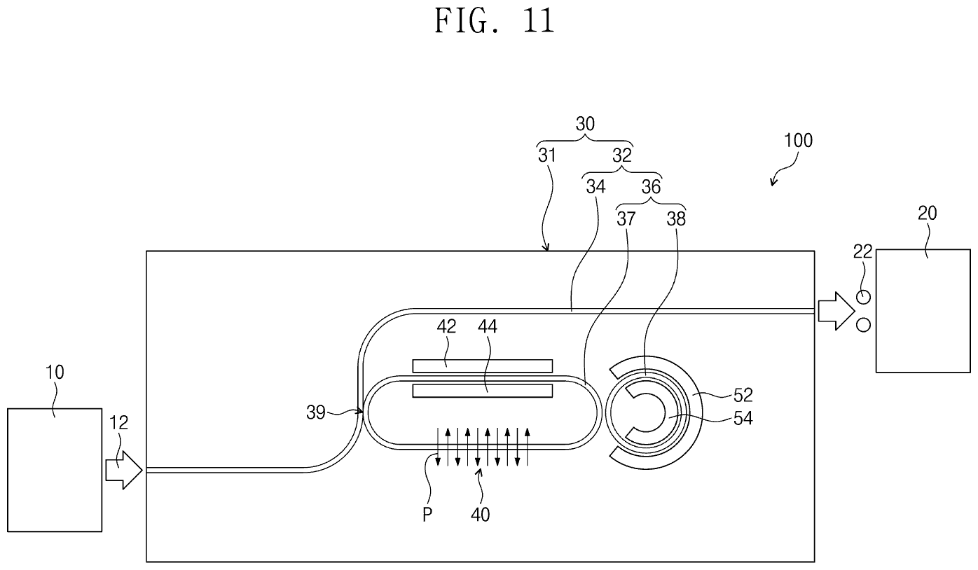

FIG. 11 shows an example optical system 100 according to the present inventive concept.

Referring to FIG. 11, the resonant waveguide 36 of the quantum light source device 30 of the inventive concept may include a main resonant waveguide 37 and an auxiliary resonant waveguide 38.

The main resonant waveguide 37 may be provided adjacent to the signal waveguide 34. The main resonant waveguide 37 may have a rounded rectangular or circular shape when viewed from a plan view. The periodic polarization inversion structure 40 may be provided on one side of the main resonant waveguide 37.

A first outer resonant electrode 42 and a first inner resonant electrode 44 may be provided in the other side of the main resonant waveguide 37. The first outer resonant electrode 42 may be provided out of the main resonant waveguide 37. The first inner resonant electrode 44 may be provided in the main resonant waveguide 37. Each of the first outer resonant electrode 42 and the first inner resonant electrode 44 may have a larger linewidth than the main resonant waveguide 37. The first outer resonant electrode 42 and the first inner resonant electrode 44 may be used as control electrodes configured to control the resonance intensity of the photon pair 22.

The auxiliary resonant waveguide 38 may be provided in one side of the main resonant waveguide 37 facing the signal waveguide 34. The auxiliary resonant waveguide 38 may be smaller than the main resonant waveguide 37 when viewed in a plan view. The auxiliary resonant waveguide 38 may more precisely control the generation efficiency and wavelength of the photon pair 22.

A second outer resonant electrode 52 and a second inner resonant electrode 54 may be provided in one side of the auxiliary resonant waveguide 38 facing the main resonant waveguide 37. The second outer resonant electrode 52 may be provided out of the auxiliary resonant waveguide 38. The second inner resonant electrode 54 may be provided in the auxiliary resonant waveguide 38 adjacent to the second outer resonance electrode 52. Each of the second outer resonant electrode 52 and the second inner resonant electrode 54 may have a larger linewidth than the auxiliary resonant waveguide 38. The second outer resonant electrode 54 and the second inner resonant electrode 54 may be used as control electrodes configured to additionally control the resonance intensity of the photon pair 22.

The pump light source 10, the light detector 20, the signal waveguide 34, and the periodic polarization inversion structure 40 may be configured identically to those of FIG. 1.

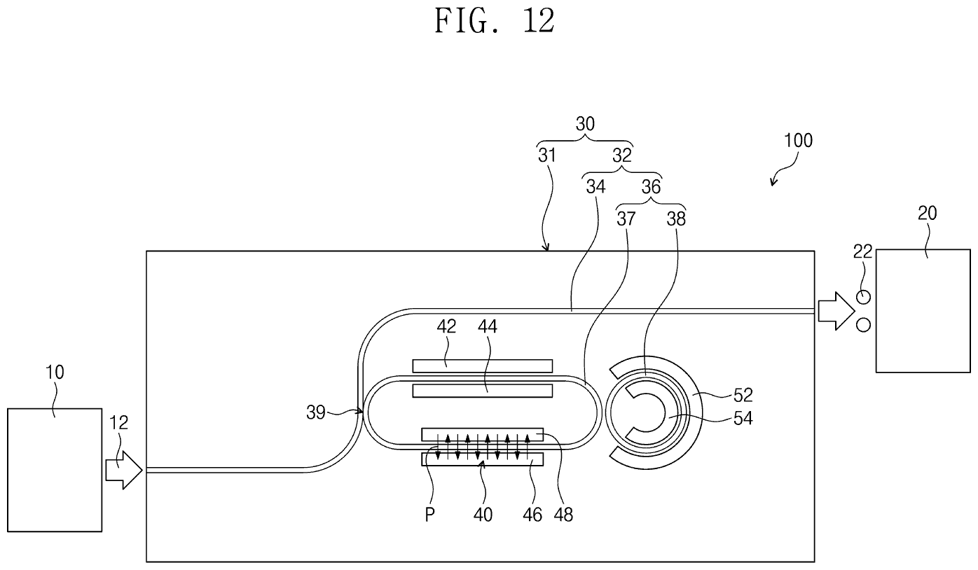

FIG. 12 shows an example optical system 100 according to the present inventive concept.

Referring to FIG. 12, the quantum light source 30 of the inventive concept may further include a third outer resonant electrode 46 and a third inner resonant electrode 48.

The third outer resonant electrode 46 and the third inner resonant electrode 48 may be provided in both sides of the periodic polarization inversion structure 40. The third outer resonant electrode 46 may be provided out of the main resonant waveguide 37 in one side of the periodic polarization inversion structure 40. The third inner resonant electrode 48 may be provided in the main resonant waveguide 37 in the other side of the periodic polarization inversion structure 40. Each of the third outer resonant electrode 46 and the third inner resonant electrode 48 may have a larger linewidth than the main resonant waveguide 37. The third outer resonant electrode 46 and the third inner resonant electrode 48 may be used as spontaneous parametric down-conversion spectrum control electrodes of the photon pair 22.

The pump light source 10, the light detector 20, the signal waveguide 34, the resonant waveguide 36, the periodic polarization inversion structure 40, the first outer resonant electrode 42, the first inner resonant electrode 44, the second outer resonant electrode 52, and the second inner resonant electrode 54 may be configured identically to those of FIG. 11.

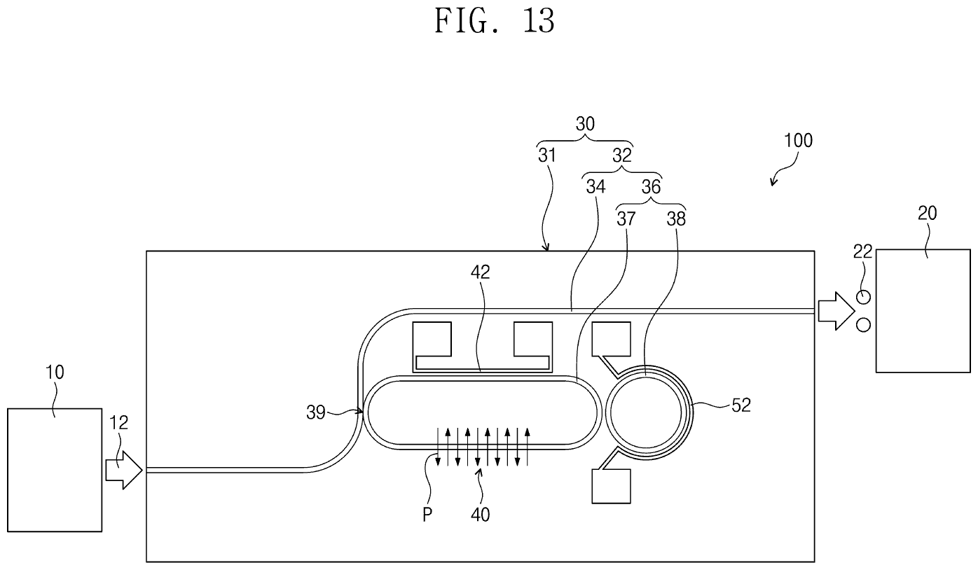

FIG. 13 shows an example optical system 100 according to the present inventive concept.

Referring to FIG. 13, the first outer resonant electrode 42 and the second outer resonant electrode 52 of the quantum light source device 30 of the inventive concept may include heater electrodes configured to heat the main resonant waveguides 37 and the auxiliary resonant waveguide 38, respectively. The first outer resonant electrode 42 may have the linewidth identical or similar to that of the main resonant waveguide 37. The first outer resonant electrode 42 may heat the main resonant waveguide 37 to control the resonant intensity and resonant frequency of the photon pair 22. The second outer resonant electrode 52 may have the linewidth identical or similar to that of the auxiliary resonant waveguide 38. The second outer resonant electrode 52 may heat the auxiliary resonant waveguide 38 to additionally control the resonant intensity and resonant frequency of the photon pair 22.

The pump light source 10, the light detector 20, the signal waveguide 34, and the periodic polarization inversion structure 40 may be configured identically to those of FIG. 11.

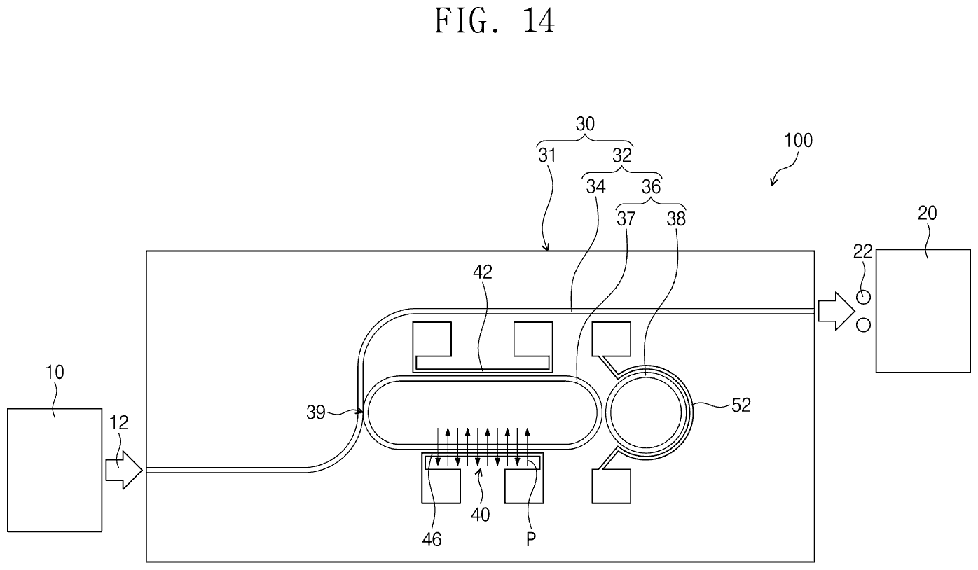

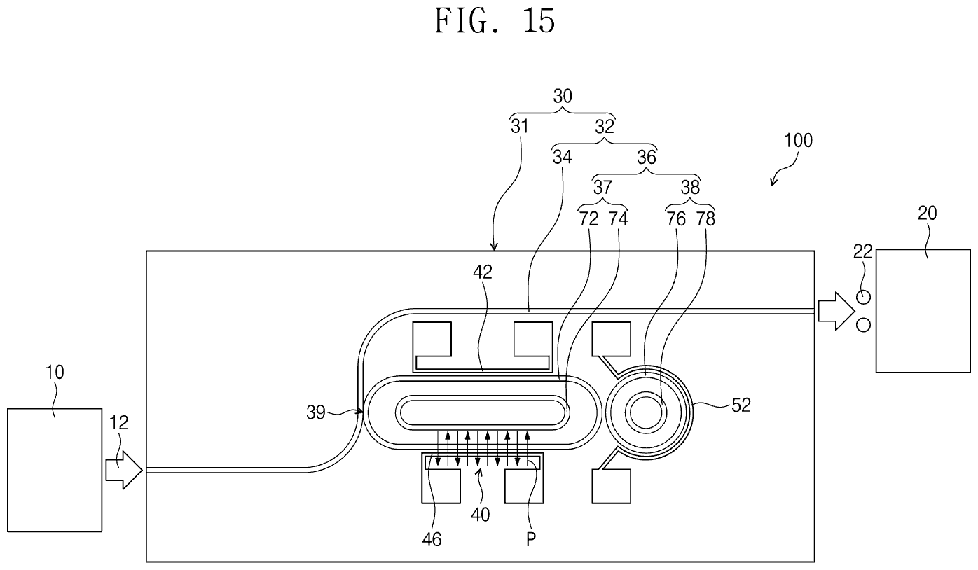

FIG. 14 shows an example optical system 100 according to the present inventive concept.

Referring to FIG. 14, the third outer resonant electrode 46 of the quantum light source 30 of the inventive concept may be a heater electrode configured to heat one side of the periodic polarization inversion structure 40. The third outer resonant electrode 46 may have the linewidth identical or similar to that of the main resonant waveguide 37. The third outer resonant electrode 46 may heat the periodic polarization inversion structure 40 or the main resonant waveguide 37 to control the spontaneous parametric down-conversion spectrum of the photon pair 22.

The pump light source 10, the light detector 20, the signal waveguide 34, the resonant waveguide 36, the periodic polarization inversion structure 40, the first outer resonant electrode 42, and the second outer resonant electrode 52 may be configured identically to those of FIG. 13.

FIG. 15 shows an example optical system 100 according to the present inventive concept.

Referring to FIG. 15, the main resonant waveguide 37 of the quantum light source device 30 of the inventive concept may include a first main resonant waveguide 72 and a second main resonant waveguide 74, and the auxiliary resonant waveguide 38 may include a first auxiliary resonant waveguide 76 and a second auxiliary resonant waveguide 78.

The first main resonant waveguide 72 may be provided adjacent to the signal waveguide 34. The first main resonant waveguide 72 may have a coupling unit 39 for the signal waveguide 34. The first main resonant circuit 72 may surround the second main resonant waveguide 74. The first main resonant waveguide 74 may be provided between the second main resonant waveguide 74 and the third outer resonant electrode 46. The periodic polarization inversion structure 40 may be provided on the first main resonant waveguide 72. The first main resonant waveguide 72 may have a rounded rectangular or circular shape when viewed from a plan view. The first main resonant waveguide 72 may use the pump light 12 to generate or resonate the photon pair 22.

The second main resonant circuit 74 may be provided in the first main resonant waveguide 72. The second main resonant waveguide 74 may have a rounded rectangular or circular shape when viewed from a plan view. The second main resonant waveguide 74 may have the same shape as the first main resonant waveguide 72. The second main resonant circuit 74 may reduce noise of the photon pair 22.

The first auxiliary resonant waveguide 76 may be provided in one side, facing the signal waveguide 34, of the first main resonant waveguide 72. The first auxiliary resonant waveguide 78 may be provided between the second auxiliary resonant waveguide 74 and the second outer resonant electrode 52. The first auxiliary resonant waveguide 76 may have a circular shape when viewed from a plan view. The first auxiliary resonant waveguide 76 may additionally resonate the photon pair 22.

The second auxiliary resonant circuit 78 may be provided in the first auxiliary resonant waveguide 76. The second auxiliary resonant waveguide 78 may have a circular shape when viewed from a plan view. The second auxiliary resonant waveguide 78 may additionally reduce the noise of the photon pair 22.

The pump light source 10, the light detector 20, the signal waveguide 34, the periodic polarization inversion structure 40, the first outer resonant electrode 42, the second outer resonant electrode 52, and the third outer resonant electrode 46 may be configured identically to those of FIG. 14.

As described above, the quantum light source device according to an embodiment of the present disclosure may use the periodic polarization inversion structure and the resonator structure in the resonant waveguide to increase or maximize the spontaneous parametric down-conversion efficiency.

The exemplary embodiments of the present disclosure have been described above with reference to the accompanying drawings, but those skilled in the art will understand that the present disclosure may be implemented in another concrete form without changing the technical spirit or an essential feature thereof. Therefore, the aforementioned exemplary embodiments are all illustrative and are not restricted to a limited form.

What is claimed is:

1. A quantum light source device comprising:
a substrate;
a buffer layer provided on the substrate; and
an optical waveguide layer provided on the buffer layer and including a signal waveguide and a resonant waveguide adjacent to one side of the signal waveguide,
wherein the resonant waveguide comprises a periodic polarization inversion structure having a plurality of polarizations periodically inverted.

2. The quantum light source device according to claim 1, wherein the optical waveguide layer comprises lithium niobate.

3. The quantum light source device according to claim 1, wherein the resonant waveguide comprises:
a main resonant waveguide adjacent to the signal waveguide; and
an auxiliary resonant waveguide spaced apart from the signal waveguide and disposed adjacent to the main resonant waveguide.

4. The quantum light source device according to claim 3, further comprising:
a first outer resonant electrode provided out of the main resonant waveguide; and
a first inner resonant electrode provided in the main resonant waveguide adjacent to the first outer resonant electrode.

5. The quantum light source device according to claim 4, further comprising:
a second outer resonant electrode provided out of the auxiliary resonant waveguide; and
a second inner resonant electrode provided in the auxiliary resonant waveguide adjacent to the second outer resonant electrode.

6. The quantum light source device according to claim 5, wherein the first and second outer resonant electrodes comprise heater electrodes.

7. The quantum light source device according to claim 3, wherein the main resonant waveguide comprises:
a first main resonant waveguide; and
a second main resonant waveguide provided in the first main resonant waveguide.

8. The quantum light source device according to claim 3, wherein the auxiliary resonant waveguide comprises:
a first auxiliary resonant waveguide; and
a second auxiliary resonant waveguide provided in the first auxiliary resonant waveguide.

9. The quantum light source device according to claim 1, further comprising:
a third outer resonant electrode provided out of the resonant waveguide and in one side of the periodic polarization inversion structure; and
a third inner resonant electrode provided in the resonant waveguide and in another side of the periodic polarization inversion structure.

10. The quantum light source device according to claim 1, wherein each of the signal waveguide and the resonant waveguide comprise a ridge waveguide.

11. An optical system comprising:
a light source configured to generate pump light;
a quantum light source device configured to use the pump light to generate a photon pair; and
a light detector configured to detect the photon pair,
wherein the quantum light source device comprises:
a substrate;
a buffer layer provided on the substrate; and
an optical waveguide layer provided on the buffer layer and comprising a signal waveguide and a resonant waveguide adjacent to one side of the signal waveguide,
wherein the resonant waveguide comprises a periodic polarization inversion structure having a plurality of polarizations periodically inverted.

12. The optical system according to claim 11, wherein each of the signal waveguide and the resonant waveguide comprises a ridge waveguide.

13. The optical system according to claim 11, wherein the optical waveguide layer comprises lithium niobate.

14. A quantum light source device comprising:
a signal waveguide;
a resonant waveguide provided at one side of the signal waveguide; and
a periodic polarization inversion structure provided on the resonant waveguide and having polarizations periodically inverted.

15. The quantum light source device according to claim 14, wherein the resonant waveguide comprises:
a main resonant waveguide adjacent to the signal waveguide; and
an auxiliary resonant waveguide spaced apart from the signal waveguide and disposed adjacent to the main resonant waveguide.

16. The quantum light source device according to claim 15, further comprising:
a first outer resonant electrode provided out of the main resonant waveguide; and
a first inner resonant electrode provided in the main resonant waveguide adjacent to the first outer resonant electrode;
a second outer resonant electrode provided out of the auxiliary resonant waveguide; and
a second inner resonant electrode provided in the auxiliary resonant waveguide adjacent to the second outer resonant electrode.

17. The quantum light source device according to claim 15, wherein the main resonant waveguide comprises:
a first main resonant waveguide; and
a second main resonant waveguide provided in the first main resonant waveguide.

18. The quantum light source device according to claim 15, wherein the auxiliary resonant waveguide comprises:
a first auxiliary resonant waveguide; and
a second auxiliary resonant waveguide provided in the first auxiliary resonant waveguide.
